(19) United States
(12) Patent Application Publication
(10) Pub. No.: US 2011/0026246 A1
(43) Pub. Date: Feb. 3, 2011

(54) LED BASED LIGHT SOURCE

(75) Inventors: Petrus Adrianus Josephus Holten, Eindhoven (NL); Giorgia Tordini, Eindhoven (NL); Vincent Fabriek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/936,544

(22) PCT Filed: Apr. 10, 2009
(86) PCT No.: PCT/IB09/51519

§ 371 Date: Oct. 6, 2010

(30) Foreign Application Priority Data
Apr. 17, 2008 (EP) 08154699.6

(51) Int. Cl. F21V 3/04; F21V 3/00; F21V 7/00

(52) U.S. Cl. 362/230; 362/235

(57) ABSTRACT

There is provided a light-emitting device (1) comprising a light source comprising a plurality of light-emitting diodes (3), said light source having a light outcoupling surface (2); a base (4); an envelope (5) covering said light source, said envelope having a maximum diameter 2*R in a direction transversal to an imaginary axis extending. through said base and said envelope, around which imaginary axis said envelope is symmetrical; and a light scattering material (6) provided in the path of light from said light outcoupling surface; wherein said light outcoupling surface is located at a position at which said envelope has a diameter D in a direction transversal to said imaginary axis, and within a distance r from said imaginary axis, r is less or equal to D/4. The light emitting device provides high efficiency in terms of light flux in the forward direction in relation to the total flux from the light source.

### FIELD OF THE INVENTION

The present invention relates to a light-emitting device comprising a light source comprising a plurality of light emitting diodes and having a light outcoupling surface, a base, an envelope covering said light source, and a light scattering material provided in the path of light from said light outcoupling surface.

### BACKGROUND OF THE INVENTION

Replacement of incandescent lamps for the reason of environmental concern is currently being performed by energy saving fluorescent lamps. Such fluorescent lamps extract about 6 times more light per watt and have a lifetime of up to 10,000 hours, which is 10 times longer than incandescent lamps. Recently, alternatives are also realised by a variety of solid state solutions, in particular light-emitting diodes (LEDs). A LED lamp requires 90% less energy than an incandescent lamp and 50% less than an energy saving fluorescent lamp, and it can burn up to 50,000 hours. Other advantages of a LED lamp with respect to a fluorescent lamp are in the instant switching on, the possibility of dimming and the use of environmental friendly components, which can be disposed as normal waste, since no mercury is present.

WO 2004/100213 discloses a LED-based light source comprising a light engine and an enclosure having the shape of a standard incandescent lamp bulb. The light emitted by the LED is converted by a wavelength converting material, which may be coated on the inside of the enclosure, or contained within the enclosure. However, a disadvantage of this light source is that a considerable part of the light flux is directed towards the lamp base where it is absorbed, resulting in a low application efficiency. Additionally, a high luminance value is obtained, which results in an uncomfortably high glare level.

Thus, there is a need in the art for an improved energy saving lamp to replace traditional incandescent lamps.

### SUMMARY OF THE INVENTION

It is an object of the present invention to at least partly overcome the above mentioned problems of known LED-based light sources for replacing incandescent lamps.

The present invention relates to a light-emitting device comprising

a light source comprising a plurality of light-emitting diodes, said light source having a light outcoupling surface;

a base;

an envelope covering said light source, said envelope having a maximum diameter 2*R in a direction transversal to an imaginary axis extending through said base and said envelope, around which imaginary axis said envelope is symmetrical; and

a light scattering material provided in the path of light from said light outcoupling surface;

wherein said light outcoupling surface is located at a position at which said envelope has a diameter D in a direction transversal to said imaginary axis, and within a distance r from said imaginary axis, r being equal to or smaller than D/4 (r≦D/4).

By positioning the light outcoupling surface within the above mentioned distance from the central axis, high efficiency in terms of light flux in the forward direction (towards the region to be illuminated, also referred to as the application region) in relation to the total flux from the light source is obtained. Moreover, by arranging a scattering material in the path of light from the light outcoupling surface, an initial extremely high luminance of the LEDs can be transformed by the scattering material into a moderate luminance.

When the envelope has a shape similar to that of a conventional quasi-spherical bulb, which typically comprises a smaller elongate portion extending towards its base, the light emitting device produces a particularly beneficial light distribution. Therefore, in embodiments of the invention, D is equal to or smaller than 2*R, such as in the range of from R/10 to 2*R.

In embodiments of the invention, the light outcoupling surface of the light source is located closer to said base than to a distal end of said envelope. By positioning the light outcoupling surface close to the axis as described above and also close to the lamp base, a uniform illumination of the envelope is obtained while also limiting the maximum luminance, thus preventing uncomfortable glare. Preferably, the light outcoupling surface is located between a point O, which is located on said imaginary axis at a position where the envelope has its maximum diameter, and said base at a distance d from O along said imaginary axis, d being in the range of from R/2 to 4*R, such as in the range of from R/2 to 2*R, or from R/2 to 3*R/2.

In embodiments of the invention, said plurality of light-emitting diodes emits blue light.

Furthermore, the light scattering material may be a wavelength converting material. The use of a wavelength converting material in the light emitting device enables efficient production of light having a desired spectral distribution. For example, by using a light source emitting blue light in combination with a suitable wavelength converting material, white light may be obtained. The scattering material may be integrated in said envelope, and/or provided on a surface of the envelope. By arranging the scattering material at a distance from the light source, degradation of the LEDs may be reduced. Thus, the distance between the light source and the light scattering material is preferably maximised or nearly maximised. Since the light scattering material is generally better protected from external damage when it is located on the inside of the envelope than when located on the outside of the envelope, said surface of the envelope preferably faces the light source.

Furthermore, the light-emitting device may comprise a reflective material arranged to direct light towards the envelope. For example, the reflective material may be provided on the base, and/or the light source may comprise a reflective layer. A reflective material may further improve the efficacy and the efficiency of the light emitting device by directing light emitted by the light source towards the wavelength converting material and/or in a light output direction, and/or towards the envelope.

### BRIEF DESCRIPTION OF THE DRAWINGS

FIG. 1 is a schematic illustration of a light emitting device according to an embodiment of the invention.

FIG. 2 schematically illustrates the luminance distribution, the intensity distribution and the energy flux of a light emitting device according to an embodiment of the invention.

### DETAILED DESCRIPTION OF THE INVENTION

Preferred embodiments of the invention will now be described with reference to the appended drawings.

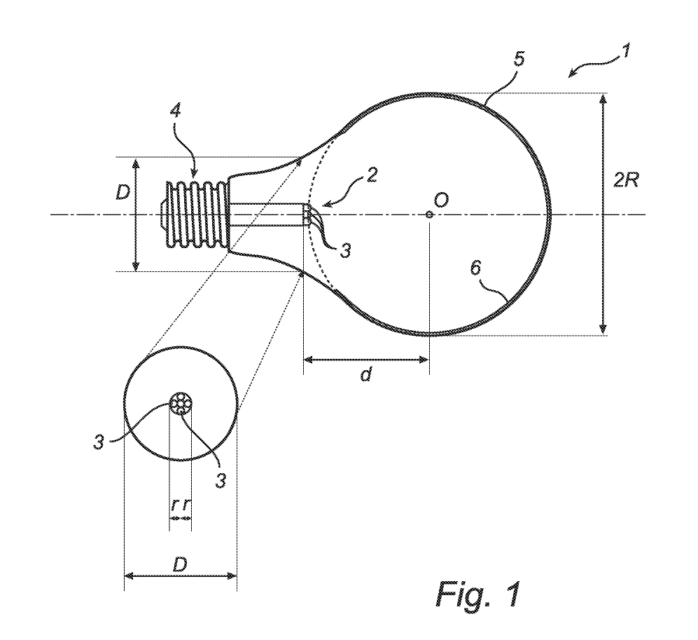

FIG. 1 shows a light emitting device 1 comprising a light source having a light outcoupling surface 2. The light source comprises a plurality of light-emitting diodes (LEDs) 3. According to the invention, the light source comprises at least two LEDs. The light source may comprise any conventional LEDs, for example a blue LED (e.g. a blue InGaN LED). The light source may be adapted to provide a light output in the range of from 100 to about 5,000 lumen.

The light outcoupling surface 2 may be a light outcoupling surface of a plurality of LEDs. The light outcoupling surface according to the invention may be an integral surface, or it may be constituted by a combination of individual light outcoupling surfaces. For example, the light outcoupling surface 2 may be the combined light outcoupling surfaces of the individual LEDs. The light outcoupling surface 2 may also be the light outcoupling surface of a light guide conducting light from a plurality of LEDs, or the combined light outcoupling surfaces of a plurality of light guides conducting light from a plurality of LEDs. Typically, light from a plurality of light-emitting diodes is transmitted through the light outcoupling surface.

The light emitting device 1 further comprises a base 4. The base 4 may be a cylindrical portion provided with an Edison screw standard cap. Examples of standard caps include E10, E12, E14, E26 and E27. Another example of a standard cap is a bayonet cap.

Furthermore, an envelope 5 covers the light source. The envelope 5 is curved and may for example have the shape of a conventional light bulb, comprising a spherical or quasi-spherical part, and an elongate, more cylindrical part extending towards the base. However, an envelope having a more elongate, pointy shape than a conventional rounded bulb is also possible, as well as an essentially cylindrically shaped envelope. The envelope may be made of any suitable material, for example a polymeric material.

The envelope has a maximum diameter 2*R defined in a direction transversal to an imaginary axis extending through the base 4 and the envelope 5, around which axis the envelope 5 is essentially symmetrical. In the case of an spherical envelope, R corresponds to its radius.

The light source is located at a position at which the envelope 5 has a diameter D in a direction transversal to the imaginary axis. The diameter D may be equal to or smaller than the maximum diameter 2*R, such as is in the range of from R/10 to 2*R.

Furthermore, the light outcoupling surface 2 is positioned within a distance r from the imaginary axis, r being equal to or smaller than D/4 (r≦D/4). By positioning the light outcoupling surface within this distance from the imaginary axis, the light emitted from the light source is efficiently distributed towards the application region. If the light outcoupling surface would be positioned at a larger distance (r>D/4) from the axis, the luminance of the envelope in the neighborhood of the light source would proportionally increase and deviate from the desired level, becoming visually disturbing. Moreover, positioning the light outcoupling surface farther from the axis would cause the light flux in the direction of the front part of the envelope to proportionally decrease, resulting in a reduced application efficiency.

With further reference to FIG. 1, the light outcoupling surface 2 of the light source is located in the vicinity of the base 4, at the edge of the quasi-spherical envelope 5. The light outcoupling surface 2 of the light source is located closer to the base 4 than to a distal end of the envelope. The distal end of the envelope is the part of the envelope that is located the furthest away from the base. In embodiments of the invention, the light outcoupling surface is located between the base and a point O, which is located on the imaginary axis at a position where said envelope has its maximum diameter, and at a distance d from O in the range of from R/2 to 4*R, preferably from R/2 to 2*R and more preferably from R/2 to 3*R/2.

In the case of an elongate, ellipsoid type envelope, d is typically larger than R. When d is equal to or smaller than 2*R (d≦2*R), the light emitting device gives most of its light in the forward direction, without compromising the comfort of the observer. When d is larger than 4*R (d>4*R), however, the performance of the light emitting device will be unsatisfactory, giving most of the light flux in a non-desired direction.

In the case of a spherically shaped envelope, it is particularly preferred to have d in the range of from R/2 to 3*R/2.

In embodiments of the invention, the light source may comprise a multi-LED package, which comprises a plurality of LED dies. For the purpose of the present application, each LED die is considered to be a separate light-emitting diode.

In the embodiment shown in FIG. 1, a wavelength converting material 6 is provided on a side of the envelope 5 facing the light source (i.e, on the inside of the envelope). The wavelength converting material is provided in the path of light from the light outcoupling surface. For example, a wavelength converting material, or any light scattering material, may be arranged between the light outcoupling surface 2 and the surface of the envelope facing away from the light source (i.e., the outer surface of the envelope). In embodiments of the invention, the light outcoupling surface 2 and the scattering material are arranged mutually spaced apart. By increasing the distance between the plurality of LEDs and the scattering material, degradation of the LEDs induced by the presence of the scattering material may be reduced. For example, a wavelength converting material may be provided as a coating on a surface of the envelope, said surface preferably facing the light source. By such an arrangement, the distance between the light outcoupling surface and the wavelength converting material can be maximised or nearly maximised. Alternatively, a scattering material such as a wavelength converting material may be integrated in the envelope.

One advantage of arranging a scattering material such as a wavelength converting material in the path of light from the light outcoupling surface as described above, in particular when the scattering material is provided as a coating on or integrated in the envelope, is the moderation of the brightness of the lamp. In the case of a blue LED based white light emitting device, the initial extremely high luminance of the LEDs can thus be transformed by the wavelength converting material into a moderate luminance, without the use of additional diffusive layers.

A wavelength converting material may absorb part of the blue light emitted by the light source and reemit light of longer wavelengths, mainly in the yellow region, although with some red and/or green components. However, the wavelength converting material may absorb radiation of wavelengths other than those of blue light, for example green light. The emission wavelengths may also be mainly in a wavelength range other than that of yellow light, such as the red or reddish light wavelength range. Also, a part of the light emitted by the light source may be transmitted by the wavelength converting material.

The wavelength converting material may comprise any conventional phosphor material, such as cerium(III)-doped YAG (usually referred to as YAG:Ce, YAG:Ce³⁺ or Y₃Al₅O₁₂:Ce³⁺) and variants thereof used for conversion of blue light. For example, a part of at least one element of Y₃Al₅O₁₂:Ce³⁺ may be replaced with another element (e.g. by substituting terbium or gadolinium for cerium and/or gallium for aluminium). Suitable wavelength converting materials for use in a light emitting device according to embodiments of the invention are known to those skilled in the art. In total, the light emitting device may produce white light.

The colour temperature of the light emitting device can be modified by altering the density of the wavelength converting material, as will be appreciated by a person skilled in the art.

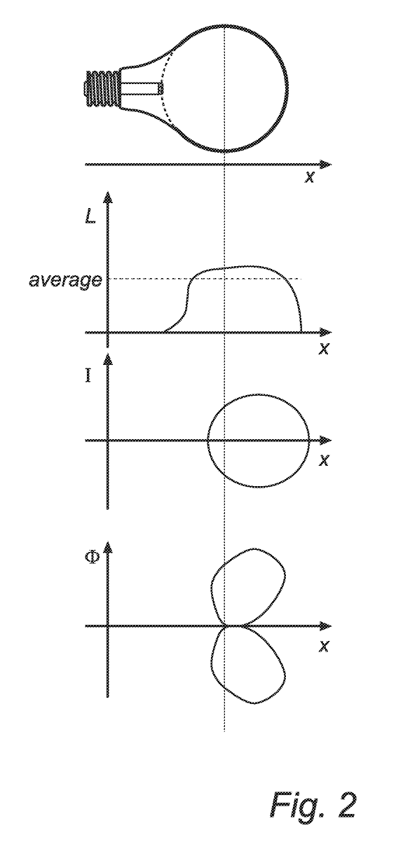

FIG. 2 shows three graphs schematically illustrating respectively the luminance distribution, the intensity distribution and the energy flux of a light emitting device according to embodiments of the invention, similar to that of FIG. 1. As can be seen, the luminance L is rather uniform within the whole of the spherically shaped envelope, so that there is little difference between the brightest point and the average luminance of the envelope. The corresponding intensity distribution I=L*A, where A is the area of the illuminated surface, has its maximum at the front of the light emitting device and gradually diminishes at the sides, and therefore the light flux Φ,

Φ=∫IdΩ,

is for about 90% directed towards the beneficial region for applications. The light emitting device thus offers both high efficacy (lumen/watt) and high application efficiency (flux towards the application/flux from the light source).

The brightest spot of a lighting device determines its glare level. By positioning the light outcoupling surface at the edge of the quasi-spherical part of the light bulb, close to the base, the luminance is rendered uniform on the whole envelope, while also limiting the maximum luminance. As a result, the light emitting device according to a preferred embodiment of the invention thus offers high comfort to the observer.

In embodiments of the invention, the light emitting device comprises a reflective material in order to further increase the efficacy of the device. The reflective material is typically arranged to direct light that is emitted or scattered in a non-desired direction towards a wavelength converting material and/or towards the envelope. For example, the light source and/or the base may be provided with a reflective layer, such as a coating.

The light emitting device according to the invention can provide uniform, light yellow light independent of its colour temperature. The light distribution of the light emitting device makes it extremely suitable for general lighting applications. Hence, the light emitting device according to the invention is particularly advantageous for replacing traditional incandescent lamps.

1. Light-emitting device (1) comprising
a light source comprising a plurality of light-emitting diodes (3), said light source having a light outcoupling surface (2);
a base (4);
an envelope (5) covering said light source, said envelope (5) having a maximum diameter 2*R in a direction transversal to an imaginary axis extending through said base (4) and said envelope (5), around which imaginary axis said envelope (5) is symmetrical; and
a light scattering material (6) provided in the path of light from said light outcoupling surface (2);
wherein said light outcoupling surface (2) is located at a position at which said envelope (5) has a diameter D in a direction transversal to said imaginary axis, and within a distance r from said imaginary axis, r≦D/4.

2. Light-emitting device (1) according to claim 1, wherein D≦2*R.

3. Light-emitting device according to claim 1, wherein D is in the range of from R/10 to 2*R.

4. Light-emitting device (1) according to claim 1, wherein said light outcoupling surface (2) is located closer to said base (4) than to a distal end of said envelope (5).

5. Light-emitting device (1) according to claim 1, wherein a point O is located on said imaginary axis at a position where said envelope (5) has its maximum diameter and wherein said light outcoupling surface (2) is located between O and said base (4) at a distance d from O along said imaginary axis, d being in the range of from R/2 to 4*R.

6. Light-emitting device according to claim 5, wherein d is in the range of from R/2 to 2*R.

7. Light-emitting device according to claim 5, wherein d is in the range of from R/2 to 3*R/2.

8. Light-emitting device according to claim 1, wherein said plurality of light-emitting diodes (3) emits blue light.

9. Light-emitting device according to claim 1, wherein said light scattering material (6) is a wavelength converting material.

10. Light-emitting device according to claim 1, wherein said light scattering material (6) is integrated in said envelope (5)

11. Light-emitting device according to claim 1, wherein said light scattering material (6) is provided on a surface of said envelope (5).

12. Light-emitting device according to claim 11, wherein said surface of said envelope (5) faces the light source.

13. Light-emitting device according to claim 1, further comprising a reflective material arranged to direct light towards said envelope.

14. Light-emitting device according to claim 13, wherein said reflective material is provided on said base (4).

15. Light-emitting device according to claim 13, wherein said light source comprises a reflective layer.
